(19) United States
(12) Patent Application Publication
(10) Pub. No.: US 2011/0291874 A1
(43) Pub. Date: Dec. 1, 2011

(54) VEHICLE RADAR SYSTEM AND METHOD FOR DETECTING OBJECTS

(76) Inventor: Bernard De Mersseman, Andover, MA (US)

(21) Appl. No.: 12/791,514

(22) Filed: Jun. 1, 2010

(51) Int. Cl. G01S 13/93

(52) U.S. Cl. 342/70

(57) ABSTRACT

A vehicle radar system and method for detecting objects are provided. The vehicle radar system includes a side radar sensor providing a detection area at a side of the vehicle and a rear radar sensor providing a detection area at a rear of the vehicle. Each of the side and rear radar sensors includes a monopulse radar device. The radar sensor system further includes a controller configured to control operation of the side and rear radar sensors.

### BACKGROUND OF THE INVENTION

The subject matter disclosed herein relates generally to vehicle radar systems, and more particularly to systems and methods for detecting objects, especially other vehicles in proximity to the radar system.

Radar systems for automotive applications are used to detect objects in proximity to a vehicle. For example, blind spot monitoring and lane change assist systems use radar technology to reduce the likelihood of collisions that occur during vehicle lane changes.

Conventional blind spot monitoring and lane change assist sensing systems use standalone radar sensors mounted to the two rear corners of the vehicle. The radar sensors are mounted to detect objects both sideways and rearwards of the sensors. These radar sensors must cover a broad area from the middle of the front door (on each side of the vehicle) to about 50 meters behind the vehicle in order to comply with certain safety standards, for example, the IS017387 standard for lane change decision aid systems (LCDAS). Covering such a wide area from a single point location increases the complexity of the antenna arrangement. For example, the conventional systems typically use multi-mode radar sensors that include electronically scanning antennas or switchable multi-beam antennas. The complexity and principle of operation of these antennas increases the size and cost of the radar sensor.

### BRIEF DESCRIPTION OF THE INVENTION

In accordance with various embodiments, a radar sensor system for a vehicle is provided. The radar sensor system includes a side radar sensor providing a detection area at a side of the vehicle and a rear radar sensor providing a detection area at a rear of the vehicle. Each of the side and rear radar sensors includes a monopulse radar device. The radar sensor system further includes a controller configured to control operation of the side and rear radar sensors.

In accordance with other embodiments, an impact avoidance and protection system for a vehicle is provided. The impact avoidance and protection system includes a pair of monopulse radar sensors and a processor. The processor is configured to receive signals from the pair of monopulse radar sensors and determine whether to report an object detected by at least one of the monopulse radar sensors. The impact avoidance and protection system further includes a warning and protection system configured to receive an activation signal from the processor to one of provide a warning indication and actuate a protection device.

In accordance with yet other embodiments, a method for detecting an object with a vehicle radar system is provided. The method includes receiving signals from a radar sensor mounted at a door of a vehicle and at a rear bumper of the vehicle and processing the received signals, using a processor, to determine whether to report an object detected by at least one of the radar sensors. The method further includes providing one of a warning indication and protection system actuation based on the report of the detected object.

### BRIEF DESCRIPTION OF THE DRAWINGS

FIG. 1 is a block diagram of a vehicle radar system constructed in accordance with various embodiments forming part of an impact avoidance and protection system.

FIG. 2 is a top view of a portion of a motor vehicle showing radar sensors and corresponding detection areas provided in accordance with various embodiments.

FIG. 3 is a perspective view of a rear bumper for a vehicle having radar sensors of various embodiments mounted thereto.

FIG. 4 is a perspective view of an inside of a door of a vehicle having radar sensors of various embodiments mounted thereto.

FIG. 5 is a flowchart of a method for processing received radar signals in accordance with various embodiments to determine whether to report a detected object.

FIG. 6 is a top view of multiple vehicles illustrating blind spot detection using a vehicle radar system in accordance with various embodiments.

### DETAILED DESCRIPTION OF THE INVENTION

The foregoing summary and brief description of drawings, as well as the following detailed description of certain embodiments, will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks may be implemented in a single piece of hardware or multiple pieces of hardware. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

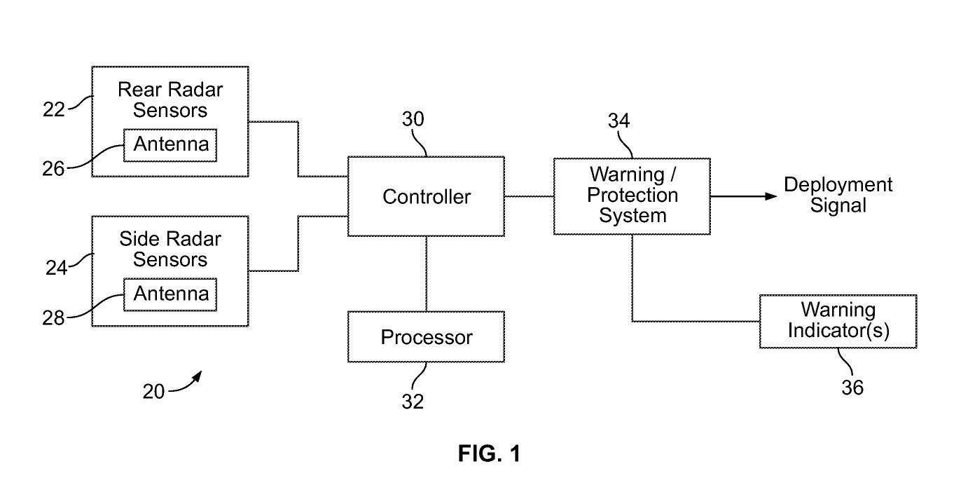

Various embodiments provide a radar system having a side and rear radar sensor arrangement, particularly for vehicles. The radar system may be provided as part of an impact avoidance and protection system 20 for a vehicle (e.g., automobile) as illustrated in FIG. 1, such as a blind spot detection and lane change assist system. The impact avoidance and protection system 20 includes a plurality of radar sensors for detecting objects that are to the side and/or rear of a vehicle. In various embodiments, the impact avoidance and protection system 20 includes rear radar sensors 22 and side radar sensors 24. For example, a rear radar sensor 22 may be mounted at each of a left rear end and a right rear end of a vehicle and a side radar sensor 24 may be mounted at each of a left side and a right side of the vehicle as described in more detail below. The rear radar sensors 22 each include an antenna 26 and the side radar sensors 24 each include an antenna 28. The rear radar sensor 22 and side radar sensor 24 on each side of vehicle may define a pair of radar sensors.

The rear radar sensors 22 and side radar sensors 24 may be any type of radar device that is capable of detecting objects (e.g., vehicles), such as detecting an object in an area adjacent to a vehicle, for example, in a blind spot of the vehicle. The objects in various embodiments are other vehicles that may be in adjacent lanes of a multi-lane road or highway with the blind spot generally defined by an area of interest that encompasses a direction of about 90 degrees to about 170 degrees from the direction of travel of the vehicle (both on the left and right sides of the vehicle). Using the impact avoidance system and protection system 20, a driver is, thus, alerted to other vehicles in close proximity, and in particular, in one or more blind spots.

The rear radar sensors 22 and side radar sensors 24 are radars having a range, for example, of between about a few centimeters up to about 50 meters. The range of the rear radar sensors 22 and side radar sensors 24 define detection areas that at least encompass the area of interest (e.g., a blind spot). The rear radar sensors 22 and side radar sensors 24 are configured and positioned to operate, for example, in blind spot monitoring and lane change assist applications, as well as for impending side and rear impact detection. The antennas 26 and 28 of the rear radar sensors 22 and side radar sensors 24, respectively, are oriented and aligned to provide the required or desired detection in the detection areas. For example, in various embodiments, the rear radar sensors 22 and side radar sensors 24 are monopulse radar devices or sensors positioned to detect an area of interest, such as from the middle of the front door to 50 meters behind the vehicle (as specified in the IS017387 standard), and that also operate to provide the additional capability to detect an impending side or rear collision. The rear radar sensors 22 and side radar sensors 24 may be different types of radar modules configured to transmit and receive, for example, at millimeter wave radar signal frequencies, such as 24 GHz (narrow band or ultra wide band) or 79 GHz (ultra wide band) frequencies. The rear radar sensors 22 and side radar sensors 24 may be, for example, monopulse Pulsed-Doppler radar sensors that operate to provide short range (typically about 0.5 meters) and medium range (typically about 50 meters) detection. Accordingly, in various embodiments the rear radar sensors 22 and side radar sensors 24 are radar devices having a monopulse antenna and pulsed modulation.

The rear radar sensors 22 and side radar sensors 24 are connected to a controller 30, such as a radar detector controller that interconnects a processor 32 with a warning and protection (warning/protection) system 34. The processor 32 receives signals from the rear radar sensors 22 and side radar sensors 24 that provide information regarding an object within a field of view of at least one of the rear radar sensors 22 and side radar sensors 24, such as within the area of interest. The information from the rear radar sensors 22 and side radar sensors 24 may include, for example, different parameters for a vehicle within the field of view of the rear radar sensors 22 and side radar sensors 24, such as a velocity of the vehicle, an angle of travel of the vehicle and the distance between a measurement point and the rear radar sensors 22 and side radar sensors 24. It should be noted that additional information may be determined or measured using the rear radar sensors 22 and side radar sensors 24 as is known.

The radar information communicated to the processor 32 is then used to determine whether a warning should be provided and/or a protection device actuation signal transmitted by the warning/protection system 34. For example, based on which of the rear radar sensors 22 and side radar sensors 24 detected an object, and the corresponding parameters for that detected object (e.g., velocity), the warning/protection system 34 may transmit a signal (e.g., activation signal) to one or more warning indicators 36 to indicate to a driver of the vehicle that an object, such as a vehicle in a blind spot, has been detected. The warnings provided by the warning indicators 36 may be any type of warning, for example, a visual (e.g., light) or audible warning, which may change based on the changing location of the other vehicle, such as proximity to the vehicle. The warning indicators 36 may be provided in different locations as are known, for example, on the side view mirror to provide blind spot warning.

Additionally, the processor 32 may determine that contact or collision with a detected object is impending, which determination may be made using any known collision detection method in the art. When a determination is made that contact or collision with the oncoming object is impending, for example, such that a driver can no longer take measures to prevent the collision, the warning/protection system 34 transmits a deployment signal (e.g., activation signal), which may be communicated to an actuator to deploy an airbag, active structure element or energy absorption mechanism, among others.

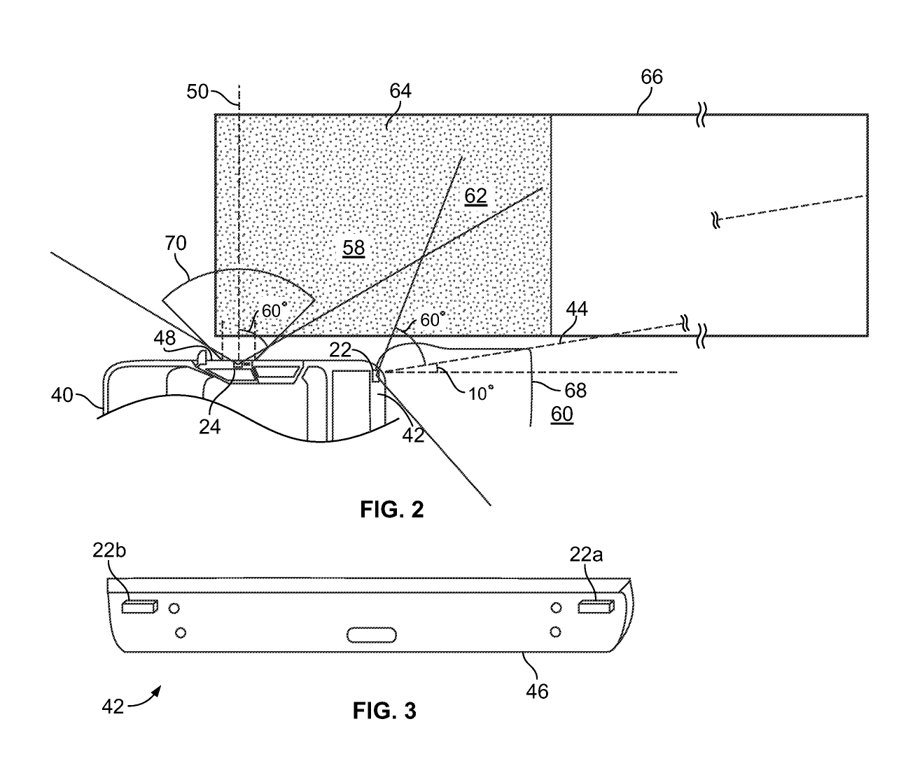

Thus, using the rear radar sensors 22 and side radar sensors 24 different detection coverage zones are provided as illustrated in FIG. 2. It should be noted that although only the right side of a vehicle 40 is shown, similar coverage zones are provided corresponding to the left side of the vehicle 40. In particular, each of the rear radar sensors 22 and side radar sensors 24 are mounted such that a centerline of the antennas 26 and 28, respectively are aligned to allow the detection area of the rear radar sensors 22 and side radar sensors 24 defined by the field of views of each to encompass the areas of interest. The illustrated configuration of FIG. 2 encompasses both rear and side coverage zones corresponding to the rear radar sensors 22 (only one is shown for simplicity) mounted at a rear portion of the vehicle 40 and the side radar sensors 24 (only one is shown for simplicity) mounted at respective side portions of the vehicle 40.

For example, in some embodiments, the rear radar sensors 22 are mounted at end portions of a rear bumper 42, such as on the bumper frame, and facing rearward with an antenna centerline 44 of the rear radar sensors 22 slightly offset from the vehicle longitudinal axis, such as offset about ten degrees from the longitudinal axis. Accordingly, the right rear radar sensor 22a located at a right rear of the vehicle 40 has an antenna centerline 44 that is offset to the right of the longitudinal axis by about ten degrees. The left rear radar sensor 22b located at a left rear of the vehicle 40 (not shown in FIG. 2) is similarly oriented at about ten degrees to the left of the longitudinal axis. Accordingly, each of the rear radar sensors 22a and 22b is oriented and turned slightly sideways from a direct rearward facing direction. As illustrated in FIG. 3, the right and left rear radar sensors 22a and 22b, respectively, are mounted to end portions of a rear bumper frame 46 of a rear bumper 42 directed slightly outwardly.

It should be noted that the offset angle may be varied as desired or needed. For example, the offset angle may be increased or decreased as desired or needed. Additionally, the right and left rear radar sensors 22a and 22b may be mounted at the rear bumper 42, such as to the rear bumper frame 46 using any suitable securing means, such as a fastener (e.g., screw, bolt, etc.), bracket, adhesive, etc. The bumper frame 46 is generally covered by a rear bumper cover as is known such that the right and left rear radar sensors 22a and 22b are not visible. Thus, in various embodiments the right and left rear radar sensors 22a and 22b are oriented to detect an impending rear collision, as well as to provide blind spot object detection.

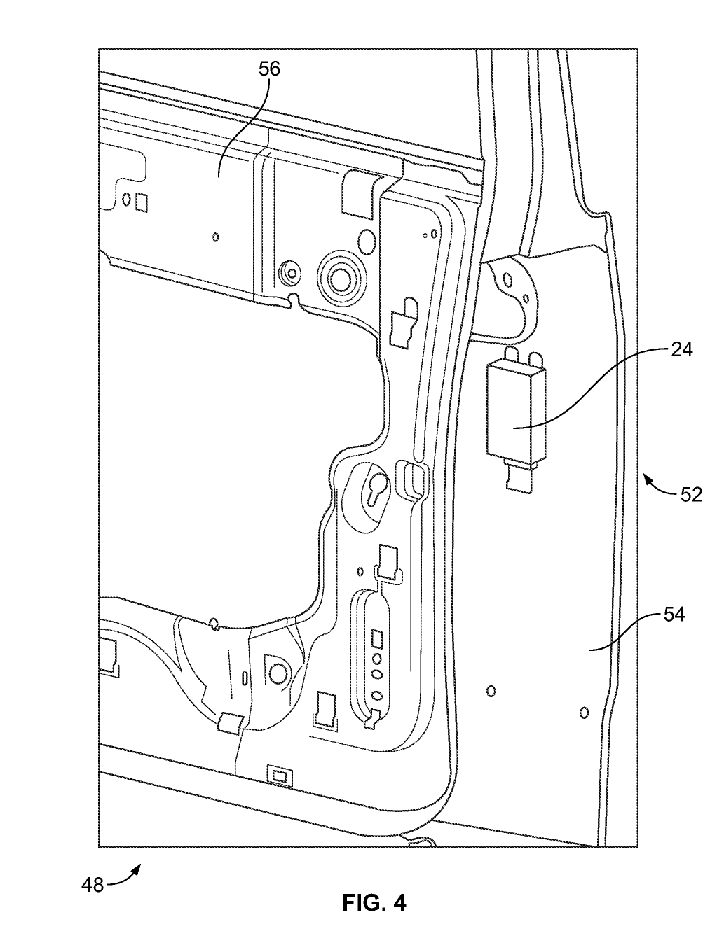

Referring again to FIG. 2, the side radar sensors 24 are mounted at a side of the vehicle 40, such as at a side door 48 of the vehicle 40. For example, the side radar sensors 24 may be mounted within a door cavity of either the front or rear side doors and facing sideways with an antenna centerline 50 of the side radar sensors 24 generally perpendicular to the longitudinal axis of the vehicle 40. Accordingly, the side radar sensors 24 have an antenna centerline 50 extending substantially sideways or laterally from the vehicle 40. The side radar sensor 24 located at a left side of the vehicle 40 is similarly positioned and oriented. Accordingly, each of the side radar sensors 24 is directed sideways and may be mounted inside a door cavity 52, such as to an inside portion of a door panel 54 that is coupled to one or more door mounting frames 56 as illustrated in FIG. 4. The side radar sensors 24 may be mounted at the side door 48 using any suitable securing means, such as a fastener (e.g., screw, bolt, etc.), bracket, adhesive, etc. Thus, similar to the rear radar sensors 22a and 22b, the side radar sensors 24 are likewise not visible. Accordingly, in various embodiments the side radar sensors 24 are oriented to detect an impending side collision, as well as to provide blind spot object detection.

The location and positioning of the rear radar sensors 22 and side radar sensors 24 may be modified. For example, the rear radar sensors 22 may be positioned closer or further away from the ends of the bumper 42 or at a different height. Additionally, the side radar sensors 24 also may be positioned closer or further from the edge of the door 48 or at a different height.

In various embodiments, the rear radar sensors 22 and side radar sensors 24 are monopulse antenna radars that each include, for example, a phase or amplitude monopulse antenna. For example, the antennas 26 and 28 in various embodiments are printed patch antennas having a wide horizontal detection area, such as, plus or minus sixty degrees. Thus, as illustrated in FIG. 2, the rear radar sensors 22 and side radar sensors 24 include a field of view defining a detection area that extend sixty degrees to each side of the antenna center lines 44 and 50, respectively. Accordingly, the detection area of the rear radar sensors 22 and side radar sensors 24 extends about 120 degrees horizontally. Thus, as illustrated in FIG. 2, the detection areas 58 and 60 provided by the rear radar sensors 22 and side radar sensors 24 include an overlapping detection region 62. It should be noted that a similar overlapping detection region may be provided behind the vehicle 40.

The rear radar sensors 22 and side radar sensors 24 thereby provide coverage in a broad area that encompasses both blind spot monitoring and lane change assist applications, as well as side and rear impact anticipation systems. For example, the detection areas 58 and 60 in some embodiments encompass the ISO 17387 coverage zones 64 and 66 for Lane Change Decision Aid Systems (LCDAS) for Class I and Class III systems, respectively, without having to use multi-mode radar sensors operating with electronically scanning antennas or switchable multi-beam antennas. The detection area 60 also encompasses in some embodiments the ISO 17386 coverage zone 68 for Maneuvering Aids for Low Speed Operation (MALSO). Thus, the detection areas 58 and 60 encompass regions and ranges that allow the use of monopulse radar sensors that provide blind spot monitoring and lane change assistance, as well as enabling detection of an impending side or rear impact.

Additionally, an LPC detection area 70 also may be provided using the side radar sensors 24. The LPC detection area 70 is defined as a region immediately adjacent the side of the vehicle 40.

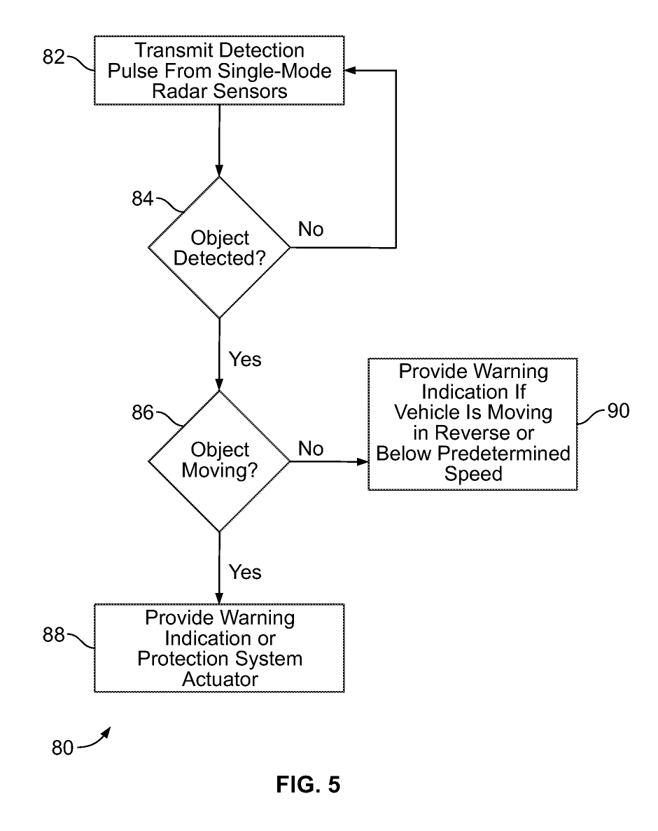

Using object detection information from the rear radar sensors 22 and side radar sensors 24, objects within the detection areas 58 and 60 may be tracked, particularly within an area of interest to determine whether to report the tracked objects. In various embodiments, radar signal processing techniques are used to track the objects. For example, radar signal processing is performed to determine whether an object is within an area of interest and then to determine whether the object is one that is of interest and should be reported, such as a moving vehicle. In some embodiments, a method 80 as shown in FIG. 5 is performed to process the received radar signals from the rear radar sensors 22 and side radar sensors 24 to determine whether to report an object within one or more detection areas, such as the detection areas 58, 60, 62 or 70. It should be noted that the determination of whether to report an object may be based on radar signal information received from one radar sensor or multiple radar sensors.

The method 80 includes transmitting detection pulses at 82 from one or more monopulse radar sensors. The monopulse radar sensors are configured and positioned to define one or more detection areas around and in proximity to a vehicle as described in more detail herein. The radar transmissions may be, for example, Pulsed-Doppler signals transmitted from the monopulse radar sensors. Thereafter, a determination is made at 84 as to whether an object is detected within one or more of the detection areas. It should be noted that objects may be detected in multiple detection areas or multiple objects may be detected in the same detection area. For example, using Pulsed-Doppler signals, a determination may be made as whether a vehicle is in a blind spot of a vehicle having the radar sensors described herein and based on detection from one of the rear radar sensors 22 and/or side radar sensors 24. The detection of the vehicle in the blind spot may be performed using any suitable radar detection technique known in the art.

Thereafter, a determination is made at 86 as to whether the object is moving. For example, using speed measurements from the radar sensors, a determination is made as to whether a vehicle in proximity to the radar sensors is moving, such as a vehicle moving in an adjacent lane of traffic and/or in a blind spot. If a determination is made that the vehicle is moving, then a warning indication and/or protection system actuation is provided at 88. Accordingly, a visual or audible warning may be provided indicating the presence of a vehicle in a detection area. The indication may indicate in which detection area the vehicle is present, for example, whether the vehicle is in a blind spot on the left side or right side of the vehicle with the radar system. In some instances, such as when the rear radar sensors 22 and/or side radar sensors 24 determine that an impact or collision is impending, which may be based on a measured speed and direction of travel of the vehicle, as well as proximity or distance from the vehicle having the radar system, actuation of a protection system may be provided. For example, a deployment signal may be transmitted to an actuator of a protection device in the vehicle, such as an airbag, active structure element or energy absorption mechanism, among others.

If a determination is made at 86 that the object is not moving, then a warning indication is provided at 90 only if certain conditions are satisfied, for example, the vehicle is moving in reverse (e.g., backing out of a driveway or parallel parking) or the vehicle is traveling below a predetermined speed, which is typically the case when a vehicle is starting up or parking. It should be noted that if an impending impact is detected while the vehicle is moving in reverse or at the slower speed, then protection system actuation may be provided if the conditions for such actuation are met, such as exceeding a predetermined minimum requirements for airbags to deploy.

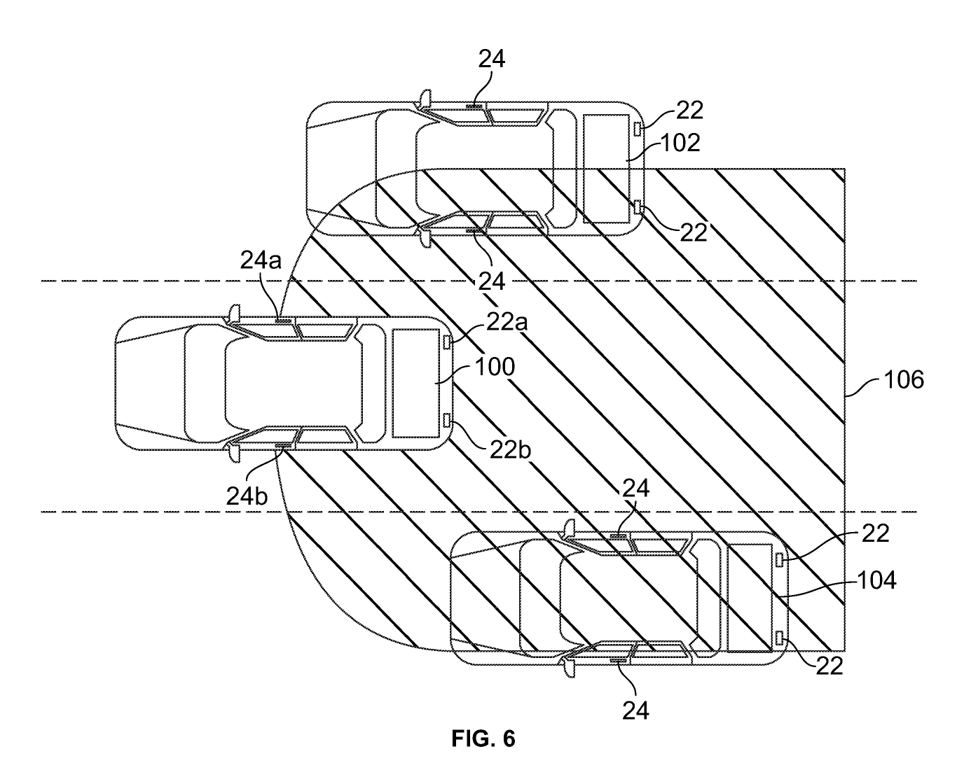

Thus, as illustrated in FIG. 6, rear radar sensors 22 and side radar sensors 24 may be mounted within one or more vehicles 100, 102 and 104. The rear radar sensors 22 and side radar sensors 24 may form part of the impact avoidance and protection system 20 for each of the vehicles 100, 102, 104. As can be seen, using the impact avoidance and protection system 20 formed in accordance with various embodiments having the rear radar sensors 22 and side radar sensors 24, a detection zone 106 is provided in proximity to the vehicle. In particular, the detection zone 106 encompasses regions to the left and right of the vehicle 100, as well as behind the vehicle 100. It should be noted that although not shown, the vehicles 102 and 104 have similar detection zones. Accordingly, the detection zone 106 provides blind spot monitoring and lane change assistance, as well as the detection of an impending side or rear impact using monopulse radar sensors that have less demanding signal processing than multi-mode radars.

Accordingly, various embodiments provide monopulse radar sensors mounted at different locations (e.g., side and rear) of a vehicle to allow detection of other vehicles in proximity to the radar sensors. The radar sensors are mounted in various embodiments to provide blind spot monitoring and lane change warnings, as well as actuation of protection systems upon detecting an impending impact or collision.

The various embodiments or components, for example, the impact avoidance and protection system 20, as well as components or controllers therein, may be implemented as part of one or more computer systems, which may be separate from or integrated with the impact avoidance and protection system 20. The computer system may include a computer having a microprocessor. The microprocessor may be connected to a communication bus. The computer may also include memories. The memories may include Random Access Memory (RAM) and Read Only Memory (ROM). The computer system further may include a storage device, which may be, for example, a hard disk drive, and the like. The storage device may also be other similar means for loading computer programs or other instructions into the computer system.

As used herein, the term “computer” may include any processor-based or microprocessor-based system including systems using microcontrollers, reduced instruction set circuits (RISC), application specific integrated circuits (ASICs), logic circuits, and any other circuit or processor capable of executing the functions described herein. The above examples are exemplary only, and are thus not intended to limit in any way the definition and/or meaning of the term “computer”.

The computer system executes a set of instructions that are stored in one or more storage elements, in order to process input data. The storage elements may also store data or other information as desired or needed. The storage element may be in the form of an information source or a physical memory element within the processing machine.

The set of instructions may include various commands that instruct the computer as a processing machine to perform specific operations such as the methods and processes of the various embodiments, for example, for processing received signals from radar sensors to identify objects within areas of interest. The set of instructions may be in the form of a software program. The software may be in various forms such as system software or application software. Further, the software may be in the form of a collection of separate programs, a program module within a larger program or a portion of a program module. The software also may include modular programming in the form of object-oriented programming. The processing of input data by the processing machine may be in response to user commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation to the teachings of the various embodiments without departing from their scope. While the dimensions and components described herein are intended to define the parameters of the various embodiments, the embodiments are by no means limiting and are exemplary embodiments. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments, including the best mode, and also to enable any person skilled in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. A radar sensor system for a vehicle, the radar sensor system comprising:
a side radar sensor providing a detection area at a side of the vehicle;
a rear radar sensor providing a detection area at a rear of the vehicle, wherein each of the side and rear radar sensors include a monopulse radar device; and
a controller configured to control operation of the side and rear radar sensors.

2. The radar sensor system of claim 1, wherein the side radar sensor faces sideways from the vehicle.

3. The radar sensor system of claim 1, wherein an antenna centerline of the side radar sensor is perpendicular to a longitudinal axis of the vehicle.

4. The radar sensor system of claim 1, wherein the rear radar sensor faces rearward from the vehicle.

5. The radar sensor system of claim 1, wherein an antenna centerline of the rear radar sensor is offset from a longitudinal axis of the vehicle.

6. The radar sensor system of claim 5, wherein the offset is about ten degrees.

7. The radar sensor system of claim 1, wherein the side radar sensor is mounted at a door of the vehicle.

8. The radar sensor system of claim 1, wherein the rear radar sensor is mounted at an end portion of a rear bumper of the vehicle.

9. The radar sensor system of claim 1, wherein the monopulse radar devices comprise one of a phase monopulse antenna and an amplitude monopulse antenna.

10. The radar sensor system of claim 1, wherein the monopulse radar devices are configured having a horizontal detection angle of +/−60 degrees.

11. The radar sensor system of claim 1, wherein the monopulse radar devices each comprise a Pulsed-Doppler sensor.

12. The radar sensor system of claim 1, wherein the side radar sensor and the rear radar sensor have overlapping fields of view.

13. An impact avoidance and protection system for a vehicle, the impact avoidance and protection system comprising:
a pair of monopulse radar sensors;
a processor configured to receive signals from the pair of monopulse radar sensors and determine whether to report an object detected by at least one of the monopulse radar sensors; and
a warning and protection system configured to receive an activation signal from the processor to one of provide a warning indication and actuate a protection device.

14. The impact avoidance and protection system of claim 13, wherein the pair of monopulse radar sensors comprise a rear radar sensor and a side radar sensor configured to detect objects at a rear and a side, respectively, of the vehicle.

15. The impact avoidance and protection system of claim 13, further comprising another pair of monopulse radar sensors, wherein the pair of monopulse radar sensors is configured to detect an object at and behind one side of the vehicle and the other pair of monopulse radar sensors is configured to detect an object at and behind an opposite side of the vehicle.

16. The impact avoidance and protection system of claim 13, wherein the processor is configured to report only moving detected objects.

17. The impact avoidance and protection system of claim 13, further comprising another pair of monopulse radar sensors, and wherein the two pairs of radar sensors are mounted on the vehicle to generate detection areas for blind spot monitoring and lane change assistance.

18. The impact avoidance and protection system of claim 13, wherein the pair of monopulse radar sensors include one sensor mountable to a side door of the vehicle and one sensor mountable to a rear bumper of the vehicle.

19. A method for detecting an object with a vehicle radar system, the method comprising:
receiving signals from a radar sensor mounted at a door of a vehicle and at a rear bumper of the vehicle;
processing the received signals, using a processor, to determine whether to report an object detected by at least one of the radar sensors; and
providing one of a warning indication and protection system actuation based on the report of the detected object.

20. The method of claim 19, wherein the radar sensors comprise monopulse radar sensors.
